(19) United States
(12) Patent Application Publication
(10) Pub. No.: US 2024/0416452 A1
(43) Pub. Date: Dec. 19, 2024

(54) LASER WELDING METHOD AND METHOD FOR MANUFACTURING ROTARY ELECTRICAL MACHINE

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP); Toshiba Industrial Products and Systems Corporation, Kawasaki-shi (JP)

(72) Inventor: Masakazu KIKAWADA, Yokohama (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP); Toshiba Industrial Products and Systems Corporation, Kawasaki-shi (JP)

(21) Appl. No.: 18/821,363

(22) Filed: Aug. 30, 2024

Related U.S. Application Data
(63) Continuation of application No. PCT/JP2022/011641, filed on Mar. 15, 2022.

(51) Int. Cl. B23K 26/082; B23K 26/21; B23K 101/36; B23K 103/12

(52) U.S. Cl. CPC B23K 26/082; B23K 26/21; B23K 2101/36; B23K 2103/12

(57) ABSTRACT

According to one embodiment, a laser welding method includes a process of irradiating the laser beam along a first movement path, a second movement path, a third movement path, and a fourth movement path at an end portion of a first wire-shaped member and a second wire-shaped member, the first movement path being loop-shaped; the second movement path being linear; the third movement path being loop-shaped; and the fourth movement path being linear.

### CROSS-REFERENCE TO RELATED APPLICATIONS

This application is based upon and claims the benefit of priority from the PCT Patent Application PCT/JP2022/011641, filed on Mar. 15, 2022; the entire contents of which are incorporated herein by reference.

### FIELD

Embodiments of the invention relate to a laser welding method, and a method for manufacturing a rotary electrical machine.

### BACKGROUND

For example, technology has been proposed in which two wire-shaped members are arranged proximate to each other, and a laser beam is irradiated on an end portion of one wire-shaped member and an end portion of the other wire-shaped member adjacent to the one wire-shaped member to weld the end portions of the two wire-shaped members to each other. In such a case, if there is a gap between the end portions of the two wire-shaped members, there is a risk that the laser beam may leak through the gap between the end portions. When the laser beam leaks through the gap between the end portions, for example, there is a risk that a coating located at the side surface of the wire-shaped member may be damaged, and/or a member located at the side opposite to the end portions of the wire-shaped members to be welded may be damaged.

Therefore, technology has been proposed in which a jig is used to closely adhere the end portions of the wire-shaped members to each other. However, the end portion of the wire-shaped member includes fluctuation of the dimensions, fluctuation of the shape, deformation, etc., and so it is difficult to prevent the occurrence of the gap between the end portions of the wire-shaped members.

Therefore, technology is proposed in which laser beams are individually irradiated respectively on the end portions of the two wire-shaped members. Thus, the laser beams can be prevented from being irradiated into the gap between the end portions of the wire-shaped members. However, such technology results in a complex configuration and/or control program of a laser welding device.

Also, technology has been proposed in which the irradiation of the laser beam is stopped when moving the irradiation position of the laser beam from the end portion of one wire-shaped member to the end portion of the other wire-shaped member. Thus, the laser beam can be prevented from being irradiated into the gap between the end portions of the wire-shaped members. However, the end portion of the wire-shaped member includes fluctuation of the dimensions, fluctuation of the shape, deformation, etc. Also, there is fluctuation of the dimensions of the gap. In such a case, the dimensions of the gap can be premeasured, and the timing of stopping the irradiation of the laser beam and/or the stopped time can be set each time. However, such technology requires a process and/or a measurement device that measures the dimensions of the gap.

It is therefore desirable to develop technology that can suppress the irradiation of the laser beam into the gap between the end portions of the wire-shaped members with a simple method.

### BRIEF DESCRIPTION OF THE DRAWINGS

FIG. 1 is a schematic perspective view illustrating a stator.

FIG. 2 is a schematic view illustrating a segment before being mounted to a core.

FIG. 3 is a schematic view illustrating the coil mounted to the core.

FIG. 4 is a schematic view illustrating laser welding of conductor parts according to a comparative example.

FIG. 5 is a schematic view illustrating laser welding of conductor parts according to another comparative example.

FIG. 6 is a schematic view illustrating laser welding of conductor parts according to the embodiment.

FIGS. 7A and 7B are schematic views illustrating movement paths of the irradiation position.

FIGS. 8A and 8B are schematic views illustrating movement paths of the irradiation position according to another embodiment.

### DETAILED DESCRIPTION

A laser welding method according to an embodiment is a laser welding method for welding an end portion of a first wire-shaped member and an end portion of a second wire-shaped member by alternately irradiating a laser beam on the end portion of the first wire-shaped member and the end portion of the second wire-shaped member, the second wire-shaped member being adjacent to the first wire-shaped member. The laser welding method includes a process of irradiating the laser beam along a first movement path at the end portion of the first wire-shaped member, the first movement path being loop-shaped; a process of stopping the irradiating of the laser beam, and moving an irradiation position of the laser beam from the end portion of the first wire-shaped member to the end portion of the second wire-shaped member along a second movement path, the second movement path being linear; a process of irradiating the laser beam along a third movement path at the end portion of the second wire-shaped member, the third movement path being loop-shaped; and a process of stopping the irradiating of the laser beam, and moving the irradiation position of the laser beam from the end portion of the second wire-shaped member to the end portion of the first wire-shaped member along a fourth movement path, the fourth movement path being linear. The second movement path contacts the first and third movement paths; and the fourth movement path contacts the first and third movement paths at a position facing the second movement path.

A laser welding method according to the embodiment can be used when end portions of wire-shaped members arranged proximate to each other are welded to each other. For example, a rotary electrical machine such as a motor, a generator, or the like includes a coil wound onto a core. In recent years, a coil that is wound onto a core is formed by inserting multiple segments into slots, and subsequently irradiating a laser beam on an end portion of a segment and on an end portion of a segment adjacent to the segment. Therefore, as an example below, the laser welding method according to the embodiment is described while illustrating a method for manufacturing a stator. In other words, the invention is applicable to a method for manufacturing a rotary electrical machine.

Also, although a wire-shaped member that has a quadrilateral cross-sectional shape (e.g., a conductor part 31a of a segment 31 described below) is illustrated to illustrate the method for manufacturing the stator, the invention also is applicable to a wire-shaped member having, for example, a polygonal cross-sectional shape, etc.

Also, in the specification, the movement path of the irradiation position of the laser beam is the movement path along which the center of the laser spot moves when the laser beam is irradiated; and when the irradiation of the laser beam is stopped, the movement path of the irradiation position is the movement path along which the center of the laser spot would move if the laser spot is assumed to be formed. For example, the movement path of the irradiation position of the laser beam can be predetermined according to the cross-sectional shape, cross-sectional dimension, etc., of the wire-shaped member (e.g., the conductor part 31a of the segment 31 described below). For example, data of predetermined movement paths is stored in a controller of a laser welding device, etc., and is used when performing the laser welding method described below.

Embodiments will now be illustrated with reference to the drawings. Similar components in the drawings are marked with the same reference numerals; and a detailed description is omitted as appropriate.

First, a stator 1 will be illustrated.

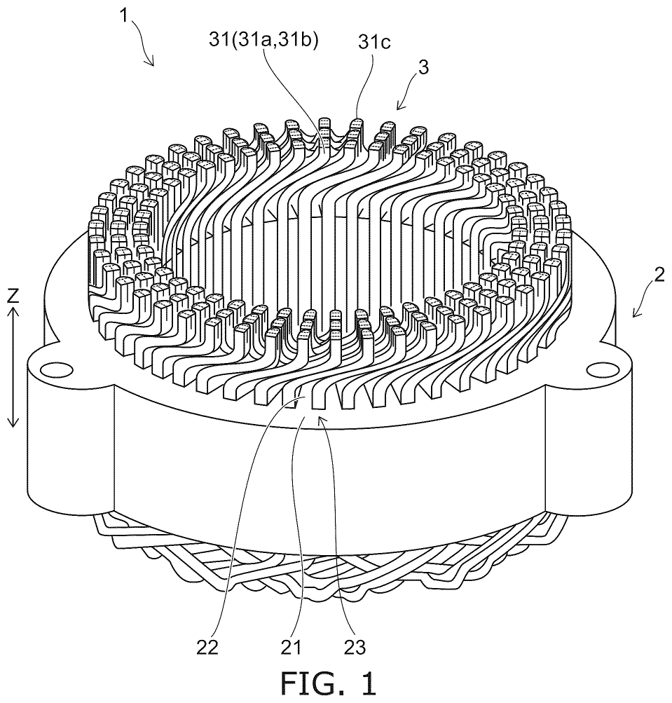

FIG. 1 is a schematic perspective view illustrating the stator 1.

As shown in FIG. 1, the stator 1 includes a core 2 and a coil 3.

In the core 2, multiple ring-shaped magnetic members can be stacked in the axial direction of the stator 1 (in FIG. 1, a Z-direction). For example, the magnetic member can be formed from an electrical steel sheet (a silicon steel sheet). The core 2 includes a yoke 21 and multiple teeth 22. The yoke 21 is tubular and is positioned at the outer circumference side of the core 2. The multiple teeth 22 are located at the inner circumferential surface of the yoke 21 at uniform spacing. Each of the multiple teeth 22 has a configuration that protrudes from the inner circumferential surface of the yoke 21 toward the center of the core 2 and extends in the axial direction of the stator 1. Also, a groove that is located between the tooth 22 and the tooth 22 is used as a slot 23. The shapes, number, and sizes of the teeth 22 are not limited to those illustrated and can be modified as appropriate according to the application, size, specifications, etc., of the rotary electrical machine in which the stator 1 is provided.

The coil 3 includes multiple segments 31.

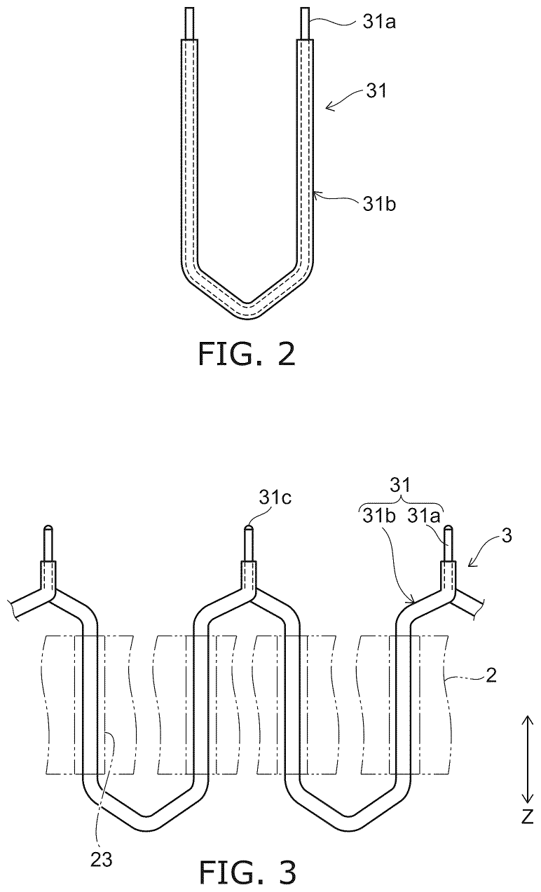

FIG. 2 is a schematic view illustrating the segment 31 before being mounted to the core 2.

As shown in FIG. 2, the segment 31 includes the conductor part 31a and an insulating film 31b. The exterior shape of the conductor part 31a before being mounted to the core 2 can be substantially U-shaped. The conductor part 31a is formed from a material having a high conductivity. For example, the conductor part 31a is formed from so-called pure copper or a material having copper as a major component. Also, the conductor part 31a can be formed from a rectangular wire. The rectangular wire is a wire-shaped member having a quadrilateral cross section. The cross-sectional dimensions of the rectangular wire can be, for example, about 1 mm to 4 mm.

The insulating film 31b covers the outer surface of the conductor part 31a. However, at the vicinity of the two end portions of the conductor part 31a, the insulating film 31b is not provided, and the conductor part 31a is exposed. The insulating film 31b includes, for example, enamel, etc.

FIG. 3 is a schematic view illustrating the coil 3 mounted to the core 2.

As shown in FIG. 3, the segment 31 is located inside the slot 23. The two ends of the segment 31 protrude from one end portion of the core 2. The portion of the segment 31 protruding from the one end portion of the core 2 extends in a direction toward the adjacent segment 31.

Also, the vicinity of the portion of the conductor part 31a exposed from under the insulating film 31b extends in the axial direction of the core 2 (in FIG. 3, the Z-direction). The portion of the conductor part 31a exposed from under the insulating film 31b overlaps the portion of the adjacent conductor parts 31a exposed from under the insulating film 31b in the circumferential direction of the core 2 (a direction around the central axis of the core 2).

The end portions of the adjacent conductor parts 31a are laser-welded to each other. One coil 3 is formed by the multiple segments 31 being connected via a weld portion 31c.

In such a case, the multiple coils 3 can be arranged in the radial direction of the core 2 (a direction passing through the central axis of the core 2 orthogonal to the Z-direction). For example, as illustrated in FIG. 1, the three coils 3 of a U-phase, a V-phase, and a W-phase can be included. The exterior shapes, number, sizes, etc., of the coils 3 and the segments 31 are not limited to those illustrated and can be modified as appropriate according to the application, size, specifications, etc., of the rotary electrical machine in which the stator 1 is provided. For example, four coils 3 may be arranged in the radial direction of the core 2.

A method for manufacturing the stator 1 will now be illustrated.

First, the core 2 is formed. For example, multiple plate-shaped magnetic members that include portions used to form the yoke 21 and the multiple teeth 22 are formed. For example, the magnetic member is formed by patterning by stamping an electrical steel sheet having a thickness of about 0.05 mm to 1.0 mm. Then, the multiple magnetic members are stacked, and the core 2 is formed by, for example, welding and/or caulking the multiple magnetic members. The core 2 also can be formed by press forming a magnetic material powder and a resin binder.

Then, the multiple segments 31 that are used as components of the coil 3 are formed.

First, the insulating film 31b is formed by applying a coating including enamel, etc., on the outer surface of a rectangular wire having a prescribed length. A coating that includes enamel, etc., may be coated onto the surface of a rectangular wire; and the rectangular wire may be cut to a prescribed length. Also, a rectangular wire that has an enamel coating, etc., may be procured, etc.; and the rectangular wire may be cut to a prescribed length.

Then, as shown in FIG. 2, the insulating film 31b at the vicinity of the two end portions of the conductor part 31a is detached to expose the conductor part 31a.

Continuing, the conductor part 31a is formed by bending the conductor part 31a into substantially a U-shape.

Thus, the multiple segments 31 can be formed.

Then, as shown in FIG. 3, each of the multiple segments 31 is mounted in prescribed slots 23 of the core 2. For example, each of the multiple segments 31 is inserted into the prescribed slots 23 from the axial direction of the core 2 (in FIG. 1, the Z-direction). In such a case, one segment 31 is inserted to straddle multiple slots 23. The coil 3 according to the embodiment can be a coil that has so-called distributed winding. Also, the coil 3 according to the embodiment can be a coil that has so-called wave winding.

Continuing as shown in FIG. 3, the portion of the segment 31 protruding from the core 2 is bent in a direction toward the adjacent segment 31. Then, furthermore, the vicinity of the portion of the conductor part 31a exposed from under the insulating film 31b is bent in the axial direction of the core 2 (in FIG. 3, the Z-direction). The portion of the conductor part 31a exposed from under the insulating film 31b overlaps the portion of the adjacent conductor part 31a exposed from under the insulating film 31b in the circumferential direction of the core 2.

Then, by repeatedly performing the procedure described above, multiple sets of the multiple segments 31 arranged in the circumferential direction of the core 2 are arranged in the radial direction of the core 2.

Although a case is illustrated where the bending is performed after mounting the multiple segments 31 in the slots 23, the bending is not limited thereto. For example, the bending of the multiple segments 31 can be performed, and each of the multiple segments 31 on which the bending is performed can be mounted in the prescribed slots 23. In such a case, the segment 31 on which the bending is performed can be mounted outward from the inner side of the core 2.

Also, the openings of the slots 23 can be covered by providing a tubular insulating cover at the inner side of the core 2 in which the multiple segments 31 are mounted.

Then, the multiple coils 3 that are mounted in the slots 23 are formed by welding the end portions of the adjacent segments 31 (conductor parts 31a) to each other.

When welding, a jig can be used to cause the end portions of the adjacent conductor parts 31a to approach each other. For example, a jig that includes a ring-shaped member located at the inner side of the multiple segments 31 arranged in the circumferential direction of the core 2 and a ring-shaped member located at the outer side of the multiple segments 31 can be used. When the ring-shaped member located at the inner side of the multiple segments 31 is mounted, one end portion of each of the multiple conductor parts 31a is pressed toward the outer side of the core 2. When the ring-shaped member located at the outer side of the multiple segments 31 is mounted, the other end portion of each of the multiple conductor parts 31a is pressed toward the inner side of the core 2. Therefore, the jig moves the end portions of the adjacent conductor parts 31a in directions toward each other. Also, the multiple conductor parts 31a are held by the jig.

The configuration of the jig is not limited to that of the example. It is sufficient for the jig to cause the end portions of the adjacent conductor parts 31a to approach each other. Also, welding can be performed without using a jig. However, by using a jig, the quality of the weld portion 31c can be improved, and/or the work efficiency of the welding operation can be improved.

The welding of the end portions of the adjacent conductor parts 31a to each other can be performed by irradiating a laser beam on the end portions of the conductor parts 31a. In other words, the end portions of the adjacent conductor parts 31a can be laser-welded to each other.

A laser beam that has a wavelength in the infrared region can be used in the laser welding. By using a laser beam having a wavelength in the infrared region, it is easy to irradiate a laser beam having a relatively high output. For example, the output of the laser beam can be about 4 kW.

The laser welding device that is used to weld the end portions of the conductor parts 31a can be, for example, a fiber laser (fiber laser) welding device, a disk laser (disk laser) welding device, etc. It is favorable for the laser welding device to be a CW laser (continuous wave laser) welding device that can continuously emit a laser beam. Also, the irradiation position of the laser beam is movable in the laser welding device. For example, the laser welding device can include a galvano mirror, etc.

Here, when the laser welding of the end portions of the conductor parts 31a is performed in ambient air, there is a risk that the weld portion 31c may oxidize, and/or the quality of the weld portion 31c may be reduced by the occurrence of blow holes, etc. Therefore, for example, it is favorable to perform the laser welding of the end portions of the conductor parts 31a in an atmosphere of an inert gas such as nitrogen gas, argon, etc., or to supply an inert gas to the vicinity of the end portions of the conductor parts 31a on which the laser welding is performed. Thus, the quality of the weld portion 31c can be improved.

The weld portion 31c illustrated in FIGS. 1 and 3 is formed by welding the end portions of the adjacent conductor parts 31a to each other. Also, one coil 3 is formed by connecting the multiple segments 31 (the conductor parts 31a) in series. Also, the multiple coils 3 that are arranged in the radial direction of the core 2 are formed. For example, the three coils 3 of the U-phase, the V-phase, and the W-phase can be formed by shifting one slot 23 each.

Details related to the welding of the end portions of the segments 31 (the conductor parts 31a) are described below.

Then, the exposed portions of the conductor parts 31a of the coil 3 are insulated by coating a resin, etc.

Then, the multiple coils 3 are fixed to the core 2. For example, varnish is dropped into the gaps between the coil 3 and the slots 23; and the coil 3 is fixed to the core 2 by curing the varnish.

Thus, the stator 1 can be manufactured.

The welds of the end portions of the segments 31 (the conductor parts 31a) will now be described further. As described above, the end portions of the adjacent conductor parts 31a are welded to each other by irradiating a laser beam on the end portions of the conductor parts 31a. In such a case, if there is a gap between the end portions of the adjacent conductor parts 31a, there are cases where the laser beam may be irradiated via the gap onto the segment 31 at the side opposite to the end portions to be welded. As shown in FIGS. 2 and 3, the insulating film 31b is located at the outer surface of the conductor part 31a. Therefore, when the laser beam is irradiated via the gap onto the segment 31 at the side opposite to the end portions to be welded, there are cases where the insulating film 31b may be damaged by the laser beam. Also, for example, there are cases where members and the like located at the segment 31 at the side opposite to the end portions to be welded may be damaged by the laser beam.

In such a case, the gap between the end portions of the adjacent conductor parts 31a can be reduced by using the jig described above. However, the end portion of the conductor part 31a includes fluctuation of the dimensions, fluctuation of the shape, deformation, etc. Therefore, even when the jig is used, it is difficult to eliminate the gap between the end portions of the adjacent conductor parts 31a.

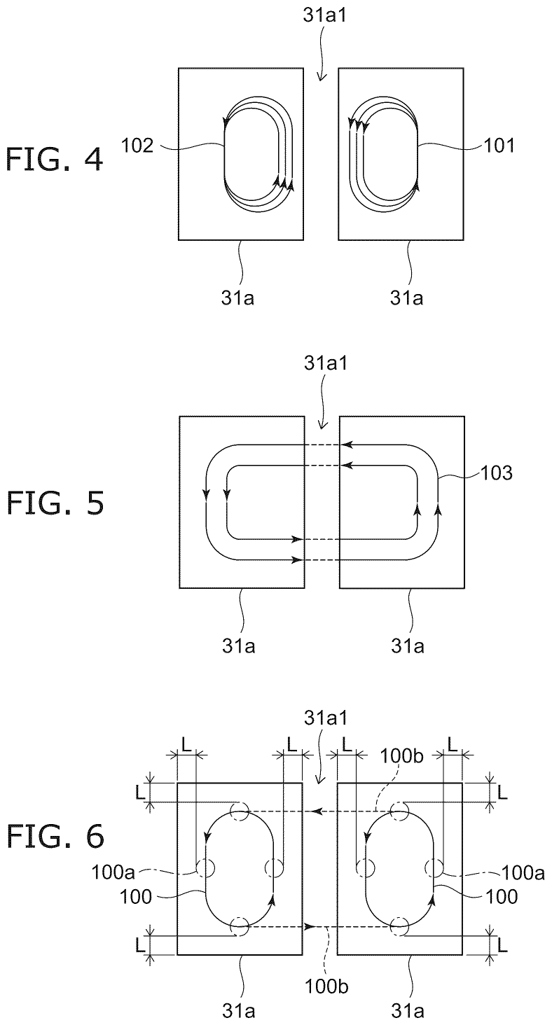

FIG. 4 is a schematic view illustrating laser welding of the conductor parts 31a according to a comparative example.

FIG. 4 shows when laser beams are individually irradiated respectively on the end portions of the adjacent conductor parts 31a. For example, as shown in FIG. 4, the laser beam is irradiated on the end portion of one conductor part 31a; and another laser beam is irradiated on the end portion of the other conductor part 31a. The laser beams are irradiated simultaneously.

A movement path 101 of the irradiation position of the laser beam at the end portion of one conductor part 31a is loop-shaped. The irradiation of the loop-shaped laser beam is continuously performed multiple times. Also, the movement path 101 of the irradiation position of the laser beam is gradually increased. By irradiating the laser beam, the end portion of the one conductor part 31a is heated to form a weld pool.

A movement path 102 of the irradiation position of the laser beam at the end portion of the other conductor part 31a is loop-shaped. The irradiation of the loop-shaped laser beam is continuously performed multiple times. Also, the movement path 102 of the irradiation position of the laser beam is gradually increased. By irradiating the laser beam, the end portion of the other conductor part 31a is heated to form the weld pool.

By gradually increasing the loop-shaped movement paths 101 and 102 of the irradiation positions of the laser beams, the weld pools that are formed fuse with each other between the end portions of the conductor parts 31a. Therefore, the end portion of the one conductor part 31a and the end portion of the other conductor part 31a are connected via the weld portion.

By individually irradiating the laser beams respectively on the end portions of the adjacent conductor parts 31a, the laser beams are not irradiated into a gap 31a1 between the end portions of the conductor parts 31a. Therefore, the insulating film 31b of the segment 31, etc., can be prevented from being damaged by the laser beams.

However, in such a technique, two laser welding devices are necessary; two optical systems are necessary to irradiate the laser beams; and/or the control programs of the laser welding devices are complex.

FIG. 5 is a schematic view illustrating laser welding of the conductor parts 31a according to another comparative example.

As shown in FIG. 5, a movement path 103 of the irradiation position of the laser beam for the two end portions of the adjacent conductor parts 31a is loop-shaped. In such a case, the irradiation of the laser beam is stopped when the irradiation position of the laser beam moves from the outer edge of the end portion of one conductor part 31a to the outer edge of the end portion of the other conductor part 31a. Also, the irradiation of the laser beam is restarted when the irradiation position of the laser beam has moved to the outer edge of the end portion of the other conductor part 31a. The loop-shaped movement path 103 of the irradiation position of the laser beam set for the end portions of the two conductor parts 31a is gradually made smaller. By irradiating the laser beam, the weld pools formed respectively at the end portions of the adjacent conductor parts 31a fuse between the end portions of the conductor parts 31a. Therefore, the end portion of one conductor part 31a and the end portion of the other conductor part 31a are connected via the weld portion.

By stopping the irradiation of the laser beam when the irradiation position of the laser beam moves from the outer edge of the end portion of the one conductor part 31a to the outer edge of the end portion of the other conductor part 31a, the laser beam is not irradiated into the gap 31a1 between the end portions of the conductor parts 31a. Therefore, the insulating film 31b of the segment 31, etc., can be prevented from being damaged by the laser beam.

However, the end portion of the conductor part 31a includes fluctuation of the dimensions, fluctuation of the shape, deformation, etc. Also, the dimensions of the gap 31a1 fluctuate. Therefore, if the irradiation of the laser beam is stopped and restarted at a predetermined timing when irradiating the laser beam and stopping the irradiation at the outer edges of the end portions of the conductor parts 31a, there is a risk that the laser beam may be irradiated into the gap 31a1. In such a case, the laser beam can be prevented from being irradiated into the gap 31a1 by increasing the time that the irradiation of the laser beam is stopped. However, in such a technique, it is difficult to heat the end portions of the conductor parts 31a because the irradiation time of the laser beam is reduced. Also, the dimensions of the gap 31a1 can be premeasured, and the timing of stopping the irradiation of the laser beam and/or the stopped time (the timing of restarting the irradiation of the laser beam) can be set each time. However, in such a technique, a process of measuring the dimensions of the gap 31a1 and a measurement device are necessary.

FIG. 6 is a schematic view illustrating laser welding of the conductor parts 31a according to the embodiment.

In the laser welding of the conductor parts 31a according to the embodiment, a laser beam is alternately irradiated on the end portion of one conductor part 31a (corresponding to an example of a first wire-shaped member) and the end portion of another conductor part 31a (corresponding to an example of a second wire-shaped member) adjacent to the one conductor part 31a to weld the end portions of the adjacent conductor parts 31a to each other.

For example, as shown in FIG. 6, the laser beam is irradiated along a loop-shaped movement path 100 (corresponding to an example of a first movement path) of the irradiation position of the laser beam at the end portion of the one conductor part 31a.

Then, the irradiation of the laser beam is stopped, and the irradiation position of the laser beam is moved from the end portion of the one conductor part 31a to the end portion of the other conductor part 31a along a linear movement path 100b (corresponding to an example of a second movement path) of the irradiation position of the laser beam.

Then, at the end portion of the other conductor part 31a, the irradiation of the laser beam is restarted, and the laser beam is irradiated along the loop-shaped movement path 100 (corresponding to an example of a third movement path) of the irradiation position of the laser beam.

Then, the irradiation of the laser beam is stopped, and the irradiation position of the laser beam is moved from the end portion of the other conductor part 31a to the end portion of the one conductor part 31a along the linear movement path 100b (corresponding to an example of a fourth movement path) of the irradiation position of the laser beam.

Thereafter, by multiply repeating the procedure described above, weld pools are formed by alternately irradiating the laser beam on the end portions of the adjacent conductor parts 31a.

In such a case, for example, the loop-shaped movement path 100 of the irradiation position can have the same shape and the same size for each of the end portions of the adjacent conductor parts 31a.

Although the loop-shaped movement path 100 of the irradiation position has the same shape and size because the cross-sectional shapes and cross-sectional dimensions of the adjacent wire-shaped members (conductor parts 31a) are the same, at least one of the shape or the size of the loop-shaped movement path 100 of the irradiation position may be different when, for example, at least one of the cross-sectional shape or the cross-sectional dimension of the adjacent wire-shaped members is different.

Hereinbelow, a case is described where the loop-shaped movement path 100 of the irradiation position has the same shape and the same size for each of the end portions of the adjacent wire-shaped members (conductor parts 31a).

The shape of the loop-shaped movement path 100 of the irradiation position is not particularly limited. However, it is favorable for the shape of the loop-shaped movement path 100 of the irradiation position to be a shape including curves such as a circle, an ellipse, or the like, or a shape including curves and straight lines such as that illustrated in FIG. 6. By setting the shape of the loop-shaped movement path 100 of the irradiation position to be such a shape, the operation of the galvano mirror or the like is smooth.

Also, the size of the loop-shaped movement path 100 of the irradiation position is not particularly limited. However, as illustrated in FIG. 6, at the end portion of one conductor part 31a, it is favorable for a shortest distance L between the outer edge of a laser spot 100a and the outer edge of the end portion of the one conductor part 31a to be constant. Also, at the end portion of the other conductor part 31a, it is favorable for the shortest distance L between the outer edge of the laser spot 100a and the outer edge of the end portion of the other conductor part 31a to be constant.

In the loop-shaped movement path 100 of the irradiation position, the laser beam is irradiated, and the end portions of the adjacent conductor parts 31a each are heated. The weld pools that are formed respectively at the end portions of the adjacent conductor parts 31a fuse between the end portions of the conductor parts 31a. Therefore, the end portion of the one conductor part 31a and the end portion of the other conductor part 31a are connected via the weld portion 31c.

Also, the irradiation of the laser beam is stopped when moving from the loop-shaped movement path 100 of the irradiation position at the end portion of the one conductor part 31a to the loop-shaped movement path 100 of the irradiation position at the end portion of the other conductor part 31a. For example, as shown in FIG. 6, a pair of linear movement paths 100b of the irradiation position connecting the loop-shaped movement path 100 of the irradiation position at the end portion of the one conductor part 31a and the loop-shaped movement path 100 of the irradiation position at the end portion of the other conductor part 31a in the direction in which the end portions of the adjacent conductor parts 31a are arranged can be provided. The movement path 100b can be a straight line (an external common tangent) contacting the two loop-shaped movement paths 100. The irradiation of the laser beam is stopped in the movement path 100b of the irradiation position.

Thus, the laser beam is not irradiated between the loop-shaped movement path 100 of the irradiation position at the end portion of the one conductor part 31a and the loop-shaped movement path 100 of the irradiation position at the end portion of the other conductor part 31a. In other words, the laser beam is not irradiated into the gap 31a1 between the end portions of the conductor parts 31a. Therefore, the insulating film 31b of the segment 31, etc., can be prevented from being damaged by the laser beam.

Also, the heating of the end portions of the conductor parts 31a is performed in the movement paths 100. Therefore, even when the irradiation of the laser beam is stopped and restarted at positions separated from the outer edges of the end portions of the conductor parts 31a in the direction in which the end portions of the adjacent conductor parts 31a are arranged, the heating of the end portions of the conductor parts 31a is not suppressed. For example, in the direction in which the end portions of the adjacent conductor parts 31a are arranged, the position at which the irradiation of the laser beam is stopped can be set to be substantially the center of the end portion of the one conductor part 31a; and the position at which the irradiation of the laser beam is restarted can be set to be substantially the center of the end portion of the other conductor part 31a. Therefore, even when the end portion of the conductor part 31a includes fluctuation of the dimensions, fluctuation of the shape, deformation, etc., and the dimensions of the gap 31a1 fluctuate, the irradiation of the laser beam into the gap 31a1 can be effectively suppressed.

Also, as shown in FIG. 6, by setting the shortest distance L between the outer edge of the laser spot 100a and the outer edge of the end portion of the conductor part 31a to be constant, the irradiation of the laser beam into the gap 31a1 can be more effectively suppressed.

Also, if the loop-shaped movement path 100 of the irradiation position has the same shape and the same size for each of the end portions of the adjacent conductor parts 31a, the control program related to the irradiation of the laser beam can be simplified.

Also, if the movement path 100b of the irradiation position is a straight line (an external common tangent) contacting the two loop-shaped movement paths 100 of the irradiation position, linear movement is possible from one movement path 100 of the irradiation position to the other movement path 100 of the irradiation position. Therefore, the movement time from the one movement path 100 of the irradiation position to the other movement path 100 of the irradiation position can be reduced, and even the takt time can be reduced.

The movement paths 100 and 100b of the irradiation position according to the embodiment will now be described further.

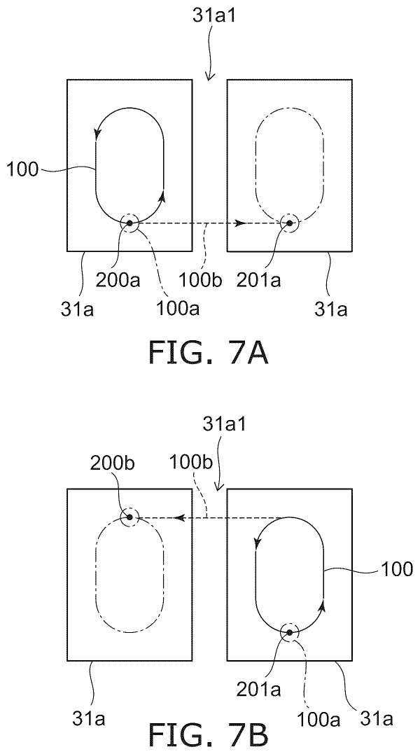

FIGS. 7A and 7B are schematic views illustrating the movement paths 100 and 100b of the irradiation position.

The laser beam is irradiated toward the end portion of one conductor part 31a; and the center of the laser spot 100a is moved along the loop-shaped movement path 100 of the irradiation position.

As shown in FIG. 7A, when the irradiation position of the laser beam (the center of the laser spot 100a) is moved in a direction from an irradiation start position 200a of the laser beam at the end portion of the one conductor part 31a toward the end portion of the other conductor part 31a (in the illustration of FIG. 7A, when the center of the laser spot 100a is moved in a counterclockwise direction) when the laser beam is initially irradiated, the center of the laser spot 100a is moved 1 turn from the irradiation start position 200a of the laser beam along the loop-shaped movement path 100 of the irradiation position. In other words, the irradiation position of the laser beam is moved 1 turn from the irradiation start position 200a of the laser beam along the loop-shaped movement path 100 of the irradiation position. Thus, the movement of the center of the laser spot 100a along the loop-shaped movement path 100 of the irradiation position can smoothly transition to the movement along the linear movement path 100b of the irradiation position.

Continuing, the irradiation of the laser beam is stopped, and the center of the laser spot 100a if the laser spot 100a is assumed to be formed is moved along the linear movement path 100b of the irradiation position to an irradiation start position 201a of the laser beam at the end portion of the other conductor part 31a.

Then, as shown in FIG. 7B, when the irradiation position of the laser beam reaches the irradiation start position 201a of the laser beam, the irradiation of the laser beam is restarted, and the center of the laser spot 100a is moved from the irradiation start position 201a of the laser beam in a direction away from the one conductor part 31a. In the illustration of FIG. 7B, the center of the laser spot 100a is moved in a counterclockwise direction. In other words, the movement direction of the laser spot 100a is the same in each of the end portions of the adjacent conductor parts 31a. Thus, the movement of the center of the laser spot 100a is smooth.

Also, the center of the laser spot 100a is moved 1.5 turns from the irradiation start position 201a of the laser beam along the loop-shaped movement path 100 of the irradiation position. In other words, at the end portion of the other conductor part 31a, the irradiation position of the laser beam is moved 1.5 turns along the movement path 100 of the irradiation position in the same direction as the movement direction of the irradiation position at the end portion of the one conductor part 31a. Thus, the movement of the center of the laser spot 100a along the loop-shaped movement path 100 of the irradiation position can smoothly transition to the movement along the linear movement path 100b of the irradiation position.

Continuing, the irradiation of the laser beam is stopped, and the center of the laser spot 100a if the laser spot 100a is assumed to be formed is moved along the linear movement path 100b of the irradiation position to an irradiation start position 200b of the laser beam at the end portion of the one conductor part 31a.

Continuing, the irradiation of the laser beam is restarted at the irradiation start position 200b of the laser beam, and the center of the laser spot 100a is moved from the irradiation start position 200b of the laser beam in a direction away from the other conductor part 31a. Thus, the movement of the center of the laser spot 100a is smooth.

Also, the center of the laser spot 100a is moved 1.5 turns from the irradiation start position 200b of the laser beam along the loop-shaped movement path 100 of the irradiation position. Thus, the movement of the center of the laser spot 100a along the loop-shaped movement path 100 of the irradiation position can smoothly transition to the movement along the linear movement path 100b of the irradiation position.

Thereafter, the center of the laser spot 100a is moved 1.5 turns along the loop-shaped movement path 100 of the irradiation position at each of the end portions of the adjacent conductor parts 31a by a similar procedure.

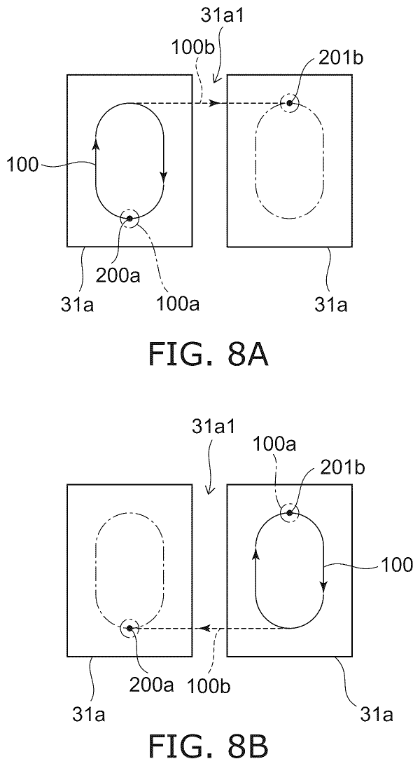

FIGS. 8A and 8B are schematic views illustrating the movement paths 100 and 100b of the irradiation position according to another embodiment.

According to the embodiment as well, as shown in FIG. 8A, the laser beam is irradiated toward the end portion of one conductor part 31a; and the center of the laser spot 100a is moved along the loop-shaped movement path 100 of the irradiation position.

However, according to the embodiment, when the laser beam is initially irradiated, the irradiation position of the laser beam (the center of the laser spot 100a) is moved from the irradiation start position 200a of the laser beam at the end portion of the one conductor part 31a in a direction away from the end portion of the other conductor part 31a. In the illustration of FIG. 8A, the center of the laser spot 100a is moved in a clockwise direction. In other words, the movement direction of the center of the laser spot 100a is the opposite of the illustration of FIG. 7A.

In such a case, the center of the laser spot 100a is moved 1.5 turns from the irradiation start position 200a of the laser beam along the loop-shaped movement path 100 of the irradiation position. In other words, the irradiation position of the laser beam is moved 1.5 turns from the irradiation start position 200a of the laser beam along the movement path 100 of the irradiation position. Thus, the movement of the center of the laser spot 100a along the loop-shaped movement path 100 of the irradiation position can smoothly transition to the movement along the linear movement path 100b of the irradiation position.

Continuing, the irradiation of the laser beam is stopped, and the center of the laser spot 100a if the laser spot 100a is assumed to be formed is moved along the linear movement path 100b of the irradiation position to an irradiation start position 201b of the laser beam at the end portion of the other conductor part 31a.

Then, as shown in FIG. 8B, when the irradiation position of the laser beam has reached the irradiation start position 201b of the laser beam, the irradiation of the laser beam is restarted, and the center of the laser spot 100a is moved from the irradiation start position 201b of the laser beam in a direction away from the one conductor part 31a. In the illustration of FIG. 8B, the center of the laser spot 100a is moved in a clockwise direction. In other words, the movement direction of the laser spot 100a is the same in each of the end portions of the adjacent conductor parts 31a. Thus, the movement of the center of the laser spot 100a is smooth.

Also, the center of the laser spot 100a is moved 1.5 turns from the irradiation start position 201b of the laser beam along the loop-shaped movement path 100 of the irradiation position. Thus, the movement of the center of the laser spot 100a along the loop-shaped movement path 100 of the irradiation position can smoothly transition to the movement along the linear movement path 100b of the irradiation position.

In other words, according to the embodiment, at the end portion of the other conductor part 31a, the irradiation position of the laser beam is moved 1.5 turns along the movement path 100 of the irradiation position in the same direction as the movement direction of the movement path 100 at the end portion of the one conductor part 31a.

Continuing, the irradiation of the laser beam is stopped, and the center of the laser spot 100a if the laser spot 100a is assumed to be formed is moved along the linear movement path 100b of the irradiation position to the irradiation start position 200a of the laser beam at the end portion of the one conductor part 31a.

Continuing, the irradiation of the laser beam is restarted at the irradiation start position 200a of the laser beam; and the center of the laser spot 100a is moved from the irradiation start position 200a of the laser beam in a direction away from the other conductor part 31a. Thus, the movement of the center of the laser spot 100a is smooth.

Also, the center of the laser spot 100a is moved 1.5 turns from the irradiation start position 200a of the laser beam along the loop-shaped movement path 100 of the irradiation position. Thus, the movement of the center of the laser spot 100a along the loop-shaped movement path 100 of the irradiation position can smoothly transition to the movement along the linear movement path 100b of the irradiation position.

Thereafter, the center of the laser spot 100a is moved 1.5 turns along the loop-shaped movement path 100 of the irradiation position at each of the end portions of the adjacent conductor parts 31a by a similar procedure.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions, and are within the scope of the inventions described in the claims and their equivalents. Also, the embodiments above can be implemented in combination with each other.

1. A laser welding method for welding an end portion of a first wire-shaped member and an end portion of a second wire-shaped member by alternately irradiating a laser beam on the end portion of the first wire-shaped member and the end portion of the second wire-shaped member, the second wire-shaped member being adjacent to the first wire-shaped member, the laser welding method comprising:
irradiating the laser beam along a first movement path at the end portion of the first wire-shaped member, the first movement path being loop-shaped;
stopping the irradiating of the laser beam, and moving an irradiation position of the laser beam from the end portion of the first wire-shaped member to the end portion of the second wire-shaped member along a second movement path, the second movement path being linear;
irradiating the laser beam along a third movement path at the end portion of the second wire-shaped member, the third movement path being loop-shaped; and
stopping the irradiating of the laser beam, and moving the irradiation position of the laser beam from the end portion of the second wire-shaped member to the end portion of the first wire-shaped member along a fourth movement path, the fourth movement path being linear,
the second movement path contacting the first and third movement paths,
the fourth movement path contacting the first and third movement paths at a position facing the second movement path.

2. The laser welding method according to claim 1, wherein
the first movement path has a same shape as the third movement path and a same size as the third movement path.

3. The laser welding method according to claim 1, wherein
a shortest distance between an outer edge of a laser spot at the end portion of the first wire-shaped member and an outer edge of the end portion of the first wire-shaped member is constant.

4. The laser welding method according to claim 1, wherein
a shortest distance between an outer edge of a laser spot at the end portion of the second wire-shaped member and an outer edge of the end portion of the second wire-shaped member is constant.

5. The laser welding method according to claim 1, wherein
when the irradiation position of the laser beam is moved from an irradiation start position of the laser beam at the end portion of the first wire-shaped member in a direction toward the end portion of the second wire-shaped member when the laser beam is initially irradiated, the irradiation position of the laser beam is moved 1 turn along the first movement path from the irradiation start position of the laser beam, and then the irradiation position of the laser beam is moved 1.5 turns along the third movement path at the end portion of the second wire-shaped member in a same direction as a movement direction of the first movement path.

6. The laser welding method according to claim 1, wherein
when the irradiation position of the laser beam is moved from an irradiation start position of the laser beam at the end portion of the first wire-shaped member in a direction away from the end portion of the second wire-shaped member when the laser beam is initially irradiated, the irradiation position of the laser beam is moved 1.5 turns along the first movement path from the irradiation start position of the laser beam, and then the irradiation position of the laser beam is moved 1.5 turns along the third movement path at the end portion of the second wire-shaped member in a same direction as a movement direction of the first movement path.

7. The laser welding method according to claim 1, wherein
a gap is provided between the end portion of the first wire-shaped member and the end portion of the second wire-shaped member.

8. The laser welding method according to claim 1, wherein
the irradiating of the laser beam along the loop-shaped first movement path at the end portion of the first wire-shaped member includes forming a weld pool at the end portion of the first wire-shaped member.

9. The laser welding method according to claim 8, wherein
the irradiating of the laser beam along the loop-shaped third movement path at the end portion of the second wire-shaped member includes forming a weld pool at the end portion of the second wire-shaped member.

10. The laser welding method according to claim 9, wherein
the weld pool formed at the end portion of the first wire-shaped member and the weld pool formed at the end portion of the second wire-shaped member fuse.

11. The laser welding method according to claim 1, wherein
a shape of the first movement path is different from a shape of the third movement path.

12. The laser welding method according to claim 1, wherein
a size of the first movement path is different from a size of the third movement path.

13. The laser welding method according to claim 1, wherein
a shape of the first movement path is a shape including a curve, or a shape including a curve and a straight line.

14. The laser welding method according to claim 1, wherein
a shape of the third movement path is a shape including a curve, or a shape including a curve and a straight line.

15. The laser welding method according to claim 1, wherein
a movement direction of the irradiation position of the laser beam in the third movement path and a movement direction of the irradiation position of the laser beam in the first movement path are a same movement direction.

16. The laser welding method according to claim 1, wherein
the laser beam has a wavelength in an infrared region.

17. The laser welding method according to claim 1, wherein
a contour of the end portion of the first wire-shaped member is quadrilateral.

18. The laser welding method according to claim 1, wherein
a contour of the end portion of the second wire-shaped member is quadrilateral.

19. The laser welding method according to claim 1, wherein
the first wire-shaped member and the second wire-shaped member are pure copper, or include copper as a major component.

20. A method for manufacturing a rotary electrical machine, the manufacturing method comprising:
disposing a coil in a plurality of slots,
the coil including a plurality of segments,
the disposing of the coil including using the laser welding method according to claim 1 to weld end portions of conductor parts of the plurality of segments.
